(19) United States
(12) Patent Application Publication
(10) Pub. No.: US 2021/0335530 A1
(43) Pub. Date: Oct. 28, 2021

(54) Solenoid Apparatus And Methods Of Assembly

(71) Applicant: Rain Bird Corporation, Azusa, CA (US)

(72) Inventors: Riccardo Tresso, Oro Valley, AZ (US); Kevin James Markley, Tucson, AZ (US); Michael Joseph Millius, Tucson, AZ (US)

(21) Appl. No.: 17/238,660

(22) Filed: Apr. 23, 2021

Related U.S. Application Data
(60) Provisional application No. 63/015,300, filed on Apr. 24, 2020.

(51) Int. Cl. H01F 7/124; H01F 7/13; H01F 7/16; H01F 7/08

(52) U.S. Cl. CPC H01F 7/124; H01F 7/13; H01F 2007/083; H01F 7/081; H01F 7/1623

(57) ABSTRACT

In one aspect, there is disclosed a solenoid having a bobbin with a core wire positioned about the bobbin to form a coil. A power supply wire is connected an end of the core wire and a frame is connected to the bobbin. An overmolded housing surrounds the core wire, the frame and a portion of the power supply wire.

### CROSS-REFERENCE TO RELATED APPLICATIONS

This application claims benefit of and priority to U.S. Provisional Application No. 63/015,300, filed Apr. 24, 2020.

### FIELD

The present application relates to solenoids and, in particular, to solenoids with improved assembly efficiency.

### BACKGROUND

Solenoids convert electrical energy into linear mechanical motion. Solenoids have been used for many years to control a variety of devices. For example, solenoids can be used in irrigation systems to control the function of a variety of devices, such as valves, rotors, and the like. In this regard, solenoids can be used in diaphragm valves, such as found in U.S. Pat. Nos. 7,694,934 and 8,740,177, to control the flow of water through the valves.

However, solenoids can be difficult and costly to manufacture. For example, the components of the solenoid are prone to shifting and movement when the housing of the solenoid is molded. As a result, prior solenoids required that the power supply wires be attached after the housing was molded since the power supply wires moved during molding.

Additionally, there is a desire to further improve the performance and efficiency of solenoids. For instance, conversion of electrical current into the magnetic field in a solenoid may vary depending on the placement and assembly of the core and windings in the solenoid. The overall magnetic field may vary depending on the configuration of the internal components of the solenoid.

### BRIEF DESCRIPTION OF THE DRAWINGS

FIG. 1 is a perspective view of a solenoid;

FIG. 2 is an exploded view of the solenoid of FIG. 1;

FIG. 3 is a perspective view of the solenoid of FIG. 1 partially assembled;

FIG. 4A is a top perspective view of the solenoid of FIG. 1 shown with a transparent housing;

FIG. 4B is a side elevational view of the solenoid of FIG. 1 shown with a transparent housing;

FIG. 4C is a bottom perspective view of the solenoid of FIG. 1 shown with a transparent housing;

FIG. 5A is a bottom perspective view of a bobbin of the solenoid of FIG. 1;

FIG. 5B is a top perspective view of the bobbin of FIG. 5A;

FIG. 5C is a front perspective view of the bobbin of FIG. 5A;

FIG. 6A is a rear perspective view of a core of the solenoid of FIG. 1;

FIG. 6B is a front perspective view of the core of FIG. 6A;

FIG. 7 is an exploded view of the core, a gasket, and a shading ring of the solenoid of FIG. 1;

FIG. 8 is a cross-section view of the solenoid of FIG. 1 taken along line 8-8 of FIG. 1;

FIG. 9A is a front perspective view of a frame or carrier of the solenoid of FIG. 1;

FIG. 9B is a rear perspective view of the carrier of FIG. 9A;

FIG. 9C is a bottom plan view of the carrier of FIG. 9A;

FIG. 10A is a bottom perspective view of the solenoid of FIG. 1 partially assembled;

FIG. 10B is a rear perspective view of the partially assembled solenoid of FIG. 10A;

FIGS. 10C-10D are a bottom perspective views of the partially assembled solenoid of FIG. 10A shown with the carrier of FIG. 9A attached;

FIG. 11 is a bottom perspective view of a partially assembled solenoid according to a second embodiment.

FIG. 12 is a perspective view of a plunger;

FIG. 13A is an exploded view of the plunger, a spring, and a sealing cap;

FIG. 13B is a perspective view of the plunger, spring, and sealing cap of FIG. 13A shown in an assembled arrangement;

FIG. 14A is a perspective view of a retainer;

FIG. 14B is a rear view of the retainer of FIG. 14A;

FIG. 15 is a perspective view of a cross-section of a portion the solenoid of FIG. 1 showing the interconnection of the retainer and bobbin;

FIG. 16A is a front view of a filter of the solenoid of FIG. 1;

FIG. 16B is a side view of the filter of FIG. 16A;

FIG. 17 is a perspective view of a terminal;

FIG. 18 is a perspective view of another form of solenoid;

FIG. 19A is a front perspective view of a frame or carrier according to another embodiment;

FIG. 19B is a rear perspective view of the carrier of FIG. 19A;

FIG. 20 is a front perspective view of the carrier of FIG. 19A with the core of FIG. 7;

FIG. 21 is a rear perspective view of a bobbin according to another embodiment;

FIG. 22A is a front perspective view of a partially assembled solenoid including the carrier of FIG. 19A and the bobbin of FIG. 21;

FIG. 22B is a rear perspective view of the partially assembled solenoid of FIG. 22A;

FIG. 23A is a perspective view of a plunger, a spring, and sealing cap according to another embodiment in an assembled arrangement; and

FIG. 23B is an exploded view of the plunger, spring, and sealing cap of FIG. 23A.

### DETAILED DESCRIPTION

Solenoids can be used to control valves, such as diaphragm valves shown in U.S. Pat. No. 8,740,177, and sprinklers where the valves are integrated into a sprinkler. Solenoids are disclosed herein which may be used to control a pilot valve associated with a main valve, e.g., a diaphragm valve. In one form, the solenoids can be used to control and relieve pressure in a control chamber of a diaphragm valve. The solenoids function by opening a flow path between the control chamber and an outlet of the diaphragm valve, thereby reducing pressure in the control chamber of the diaphragm valve. As the pressure is reduced in the control chamber, the diaphragm valve opens to permit flow through the valve. The solenoids can then close, preventing flow out of the control chamber, thereby increasing the pressure in the control chamber until the valve closes. The solenoids thus control the main valve such that the main valve opens as a result of the solenoid opening the pilot valve. However, it should be appreciated that the solenoids described herein may be used for other purposes and with other components.

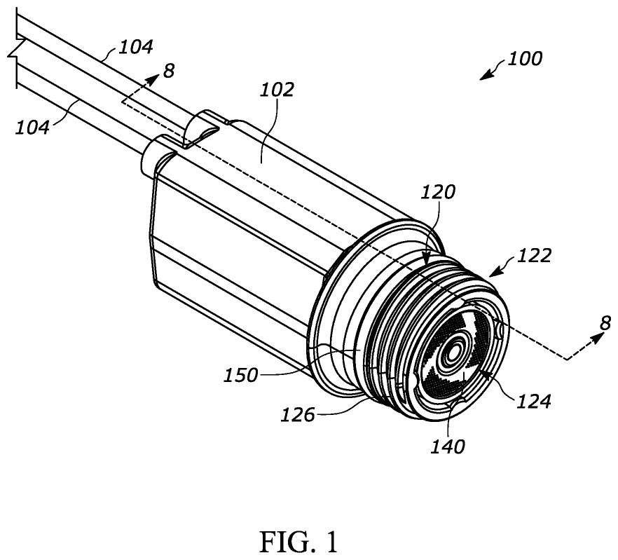

Referring to FIG. 1, a solenoid 100 is shown. The solenoid 100 includes a housing 102 containing the internal components of the solenoid 100. Two wires 104 extend from the housing 102. The wires 104 may be connected to a power supply to provide power to the solenoid 100. The attachment portion 122 of the bobbin 120 extends from the housing 102. The attachment portion 122 defines a valve cavity 124 where a filter 140 is inserted. The attachment portion 122 includes threads 126 disposed on a surface thereof for attachment to a main valve (not shown). A gasket 150 is positioned on the attachment portion 122 of the bobbin 120. The gasket 150 may prevent fluid from flowing or leaking out of the main valve when the solenoid 100 is attached to the main valve.

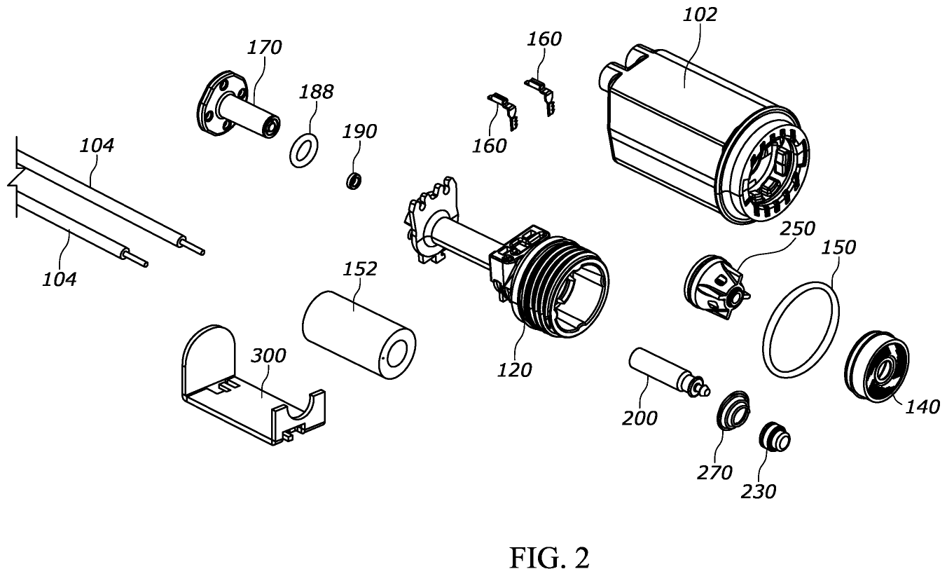

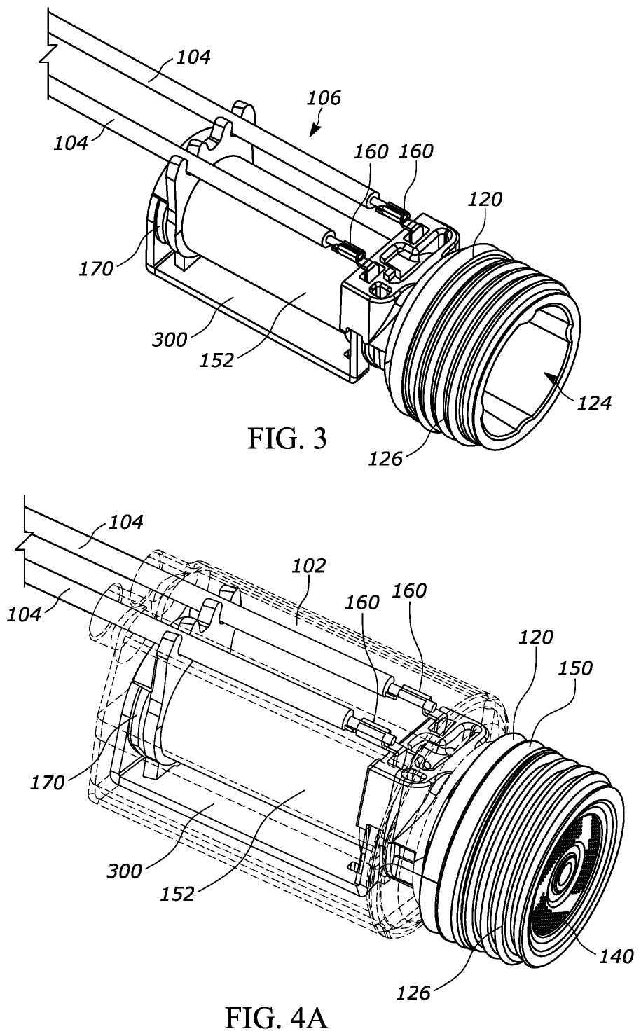

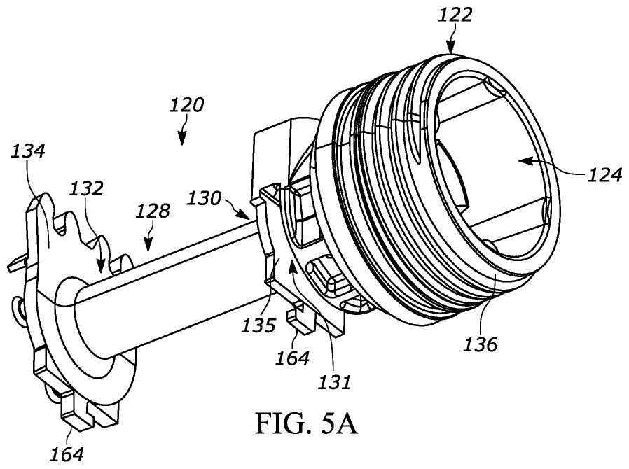

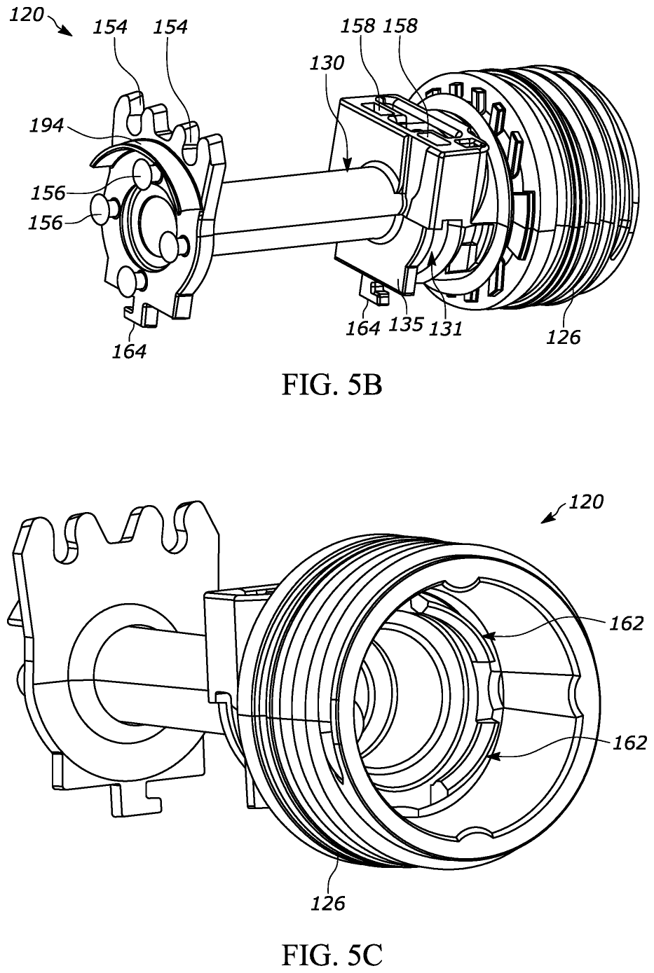

Regarding FIG. 2, an exploded view of the solenoid 100 and its components are shown. Regarding FIG. 3, a partially assembled solenoid 106 is shown. The solenoid 100 includes a bobbin 120 including a tube portion 128 (see FIGS. 5A-5C) about which a coil of wire 152 is wound. The ends of the coil of wire 152 may be connected to terminals 160. Wires 104 may also be connected to the terminals 160. A core 170 includes a portion which is inserted into the tube portion 128 of the bobbin 120 at the end opposite the valve cavity 124 of the bobbin 120. A gasket 188 may be positioned between the portion of the core 170 remaining outside of the bobbin 120 and the bobbin 120. A shading ring 190 is positioned on an end of the core 170 inserted into the bobbin 120. A plunger 200 may be inserted into the interior of the tube portion 128 of the bobbin 120. An end of the plunger 200 may be adjacent the core 170 and/or shading ring 190 within the tube portion 128 when retracted to an open position. A sealing cap 230 may be positioned over an end of the plunger 200 extending into the valve cavity 124. A retainer 250 defining a fluid flow path may be inserted into the valve cavity 124 to retain the plunger 200 within the bobbin 120. A spring 270 may extend from an internal surface of the bobbin 120 within the valve cavity 124 to the plunger 200 to bias the plunger 200 against the retainer 250. The filter 140 may be inserted in the valve cavity 124 after the retainer 250 has been inserted.

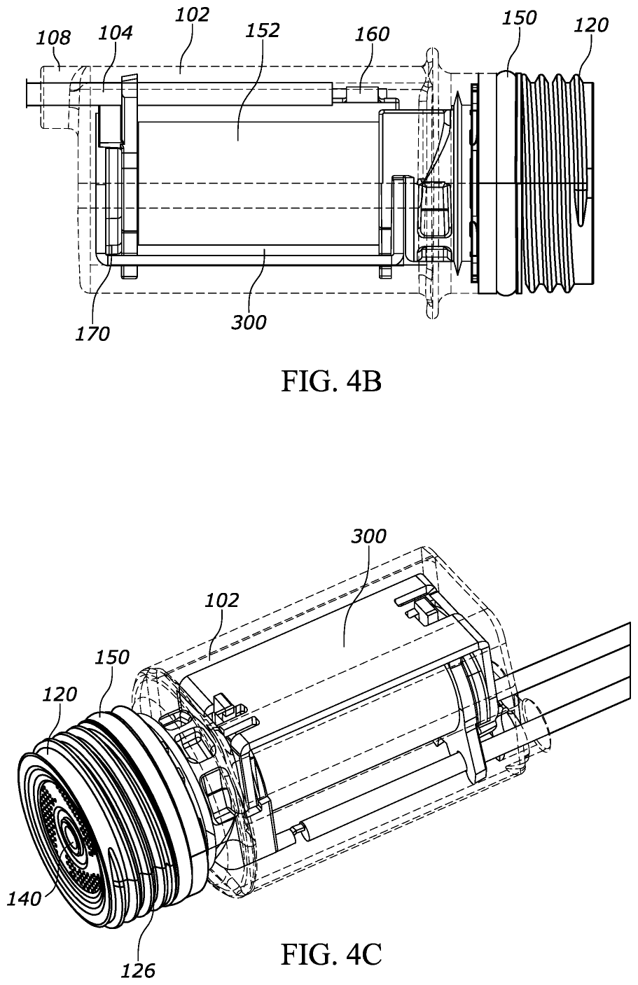

With reference to FIG. 4A-4C, the housing 102 is shown as see-through or transparent. As shown, the housing 102 surrounds and/or envelopes many of the internal components of the solenoid 100 including the C-frame or carrier 300, the core 170, the coil of wire 152, the terminals 160, a portion of the bobbin 120, a portion of the wires 104, and a portion of gasket 188. The housing 102 may be an overmold that is molded after the internal components of the solenoid 100 are partially assembled, for example, like partially assembled solenoid 106 of FIG. 3. For instance, the partially assembled solenoid 106 may be inserted into a cavity with an overmold dispersed about the solenoid 100. The attachment portion 122 of the bobbin 120 may be inserted into a cavity such that the attachment portion 122 is not enveloped by the overmold. The overmold may be a variety of materials such as plastics, polybutylene terephthalate (PBT), nylon, other polymers, and the like. As shown in FIGS. 4A-4C, the wires are overmolded after being attached to the terminals 160. The overmold may form wire support knobs 108 which protrude from the surface of the housing 102 opposite the attachment portion 122 of the bobbin 120. The knobs 108 may aid to prevent water from entering the housing 102 and reaching the coil 152.

With reference to FIGS. 5A-5C, the bobbin 120 of the solenoid 100 includes a tube portion 128 and the attachment portion 122. The tube portion 128 has a first end 130 that terminates at the valve cavity 124 and a second end 132 that terminates at an end surface 134 that is substantially perpendicular to the tube portion 128. The attachment portion 122 includes a cylindrical skirt 136 defining the valve cavity 124. The cylindrical skirt 136 includes threads 126 disposed on an outer surface thereof for attachment within a cavity including complementary threads 126, such as an opening of a diaphragm valve. In another embodiment, the threads 126 may be disposed on an inner surface of the cylindrical skirt 136. Other methods of attaching the solenoids may also be used, such as snap fit, extended protrusions, and the like. The cylindrical skirt 136 includes an annular recess 138 that receives a gasket 150. The gasket 150 may be as an example, an O-ring. The gasket 150 aids in forming fluid tight connection between the solenoid 100 and the object the solenoid 100 is connected to, for example, a main valve that the solenoid 100 is threaded into. The end surface 134 includes wire guides 154 for guiding and supporting wires 104 extending from the terminals 160 to the power source. In one form, the wire guides 154 may be horseshoe-shaped recesses in the end surface 134 that the wires 104 may snap or be pressed into. The wire guides 154 may be sized to receive a specific gauge wire. The wire guides 154 may retain the wires 104 in the position they are inserted at, requiring force to dislodge the wires 104 to mitigate unintentional removal of the wires. The wire guides 154 aid in manufacturing of the solenoid 100 by maintaining the wires 104 in a fixed location, for example, when the partially assembled solenoid 106 is overmolded to form housing 102.

The bobbin 120 further includes protrusions 156 that extend longitudinally from the end surface 134. These protrusions 156 are positioned and arranged to be received through complementary apertures 172 of the core 170. The ends of the protrusions 156 may be deformable, such as through heat staking. The ends of the protrusions 156 may be deformed after the protrusions 156 have been inserted through the apertures 172 of the core 170 to couple the core 170 to the bobbin 120. The protrusions 156 may be formed to include a specific volume of plastic such that when deformed, the plastic remains within the apertures 172 of the core 170. Further, the apertures 172 may be shaped to accept the deformed protrusions 156 and otherwise prevent the protrusions 156 from extending beyond the apertures 172. Coupling the core 170 to the bobbin 120 aids in managing the partially assembled solenoid 106 during manufacturing, particularly when the partially assembled solenoid 106 is transferred for overmolding.

A shroud 194 may protrude longitudinally from the end surface 134. In one form, the shroud 194 may be rounded and shaped to extend over the portion of the carrier 300 and core 170 at the end surface 134. The shroud 194 may be included on the bobbin 120 to prevent and/or redirect the overmold from flowing between the core 170 and the carrier 300 during the molding process to preserve the magnetic circuit interface between the core 170 and the carrier 300.

At the first end 130 of the tube portion 128 of the bobbin 120, the bobbin 120 includes another end surface 135. The coil 152 may be wound about the tube portion 128 between the end surfaces 134, 135. The bobbin 120 may further include sockets 158 formed between the end surface 135 and the attachment portion 122 that receive the terminals 160. An end of the terminals 160 may be inserted into each of the sockets 158. The sockets 158 may be sized to retain the terminals 160 to prevent the terminals 160 from becoming unintentionally dislodged after being inserted into the socket 158, for example, by a friction fit. The bobbin 120 may further define a cavity or slot 131 between the end surface 135 and the attachment portion 122 of the bobbin 120 that receives the second end surface 304 of the carrier 300.

Within the valve cavity 124 of the bobbin 120, the bobbin 120 includes retention members 162 to connect retainer 250. The retention members 162 may be deflectable snap-in hooks that snap over a complementary ridge 252 of the retainer 250. The retention members 162 may be in an annular arrangement with a gap in between each retention member 162. Including a gap in between the retention members 162 may be desired in embodiments where the bobbin 120 is formed of a material that resists outward deflection when the retainer 250 is inserted. While the retention members 162 are shown in FIG. 5C as being spaced apart by gaps, in alternative embodiments, there may be a single annular retention member 162 that does not include any gaps. In other embodiments, there may be a single annular retention member 162 that includes a single gap to allow the retention member 162 to deflect outward to receive the retainer 250.

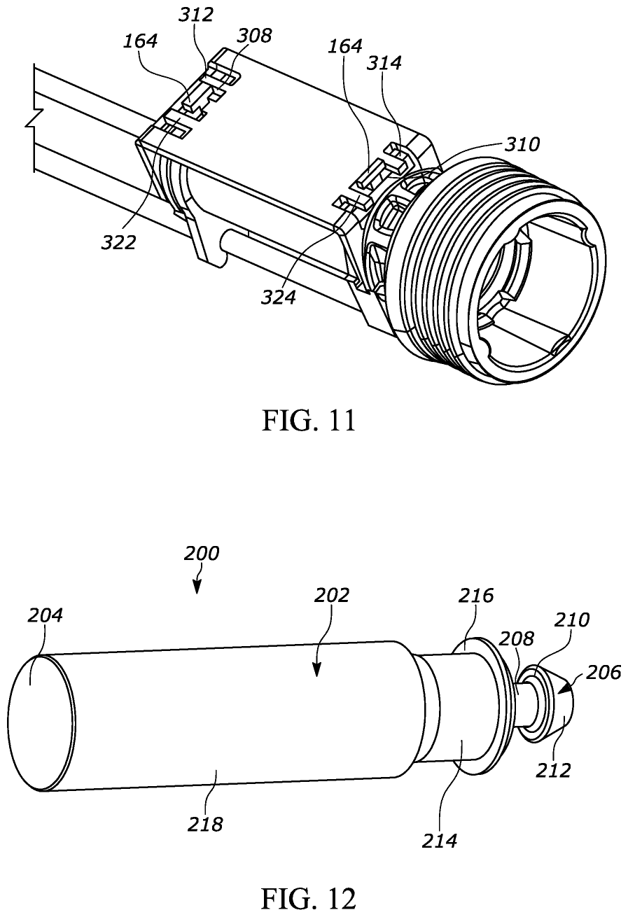

The bobbin 120 also includes hooks 164 extending from the bottom portion of the bobbin 120. As shown in FIGS. 5A-5C, the hooks 164 have a half-T formation. The hooks 164 may have a full T-shape formation, as seen in FIG. 11. In other embodiments, the bobbin 120 may include one full T-shape hook 164 and one half-T shape hook. The hooks 164 engage a portion of the carrier 300 to connect the carrier 300 to the bobbin 120, which is described in more detail below with regard to the carrier 300.

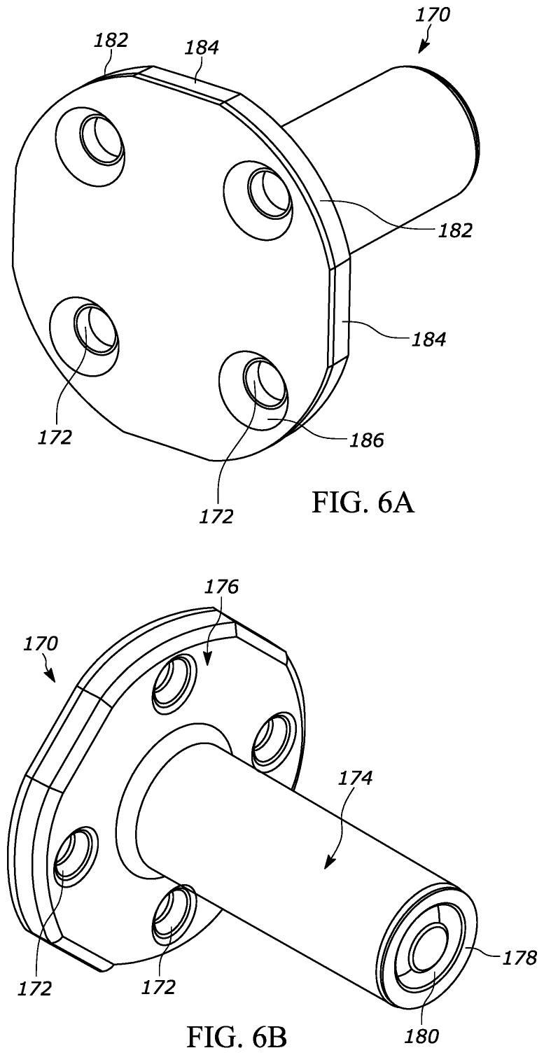

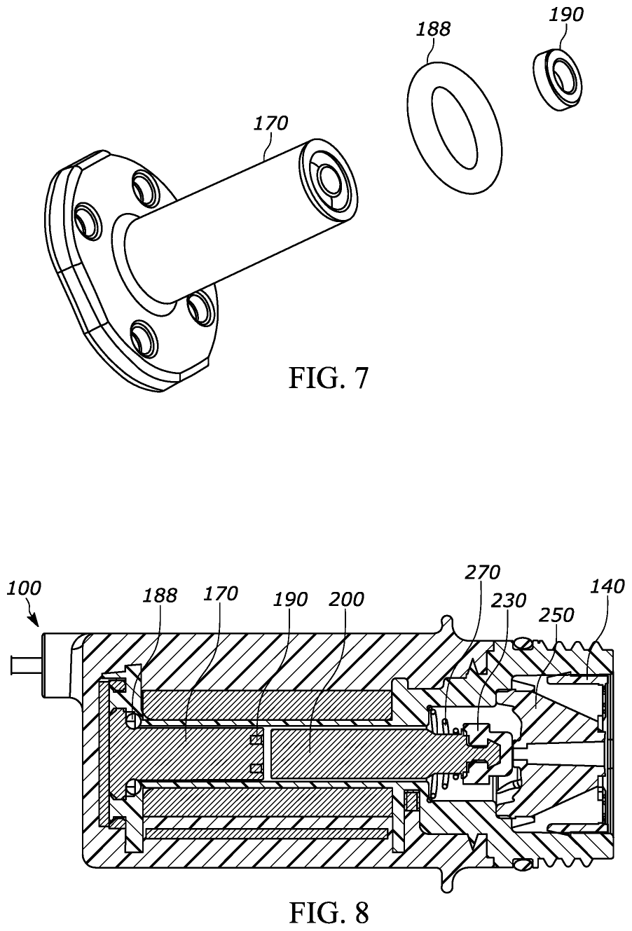

With reference to FIGS. 6A-6B and FIG. 7 the core 170 includes a rod portion 174 and a disc portion 176. The rod portion 174 extends into the second end 132 of the tube portion 128 of the bobbin 120, for example as shown in FIG. 8. The end surface 178 of the rod portion 174 includes an annular recess 180 sized to receive a shading ring 190. The shading ring 190 may be made of a metal, for example, copper. The shading ring 190 may be pressed into the annular recess 180 and held in place by a friction fit. The shading ring 190 may extend longitudinally beyond the end surface 178 of the core 170 and may reduce vibration and chatter between the core 170 and the plunger 200 when the plunger 200 is drawn to the core 170 during energization of the solenoid 100. In another embodiment, the shading ring 190 may be melted into the annular recess 180 of the core 170 to affix the shading ring 190 to the core 170. For example, during assembly of the solenoid 100, the shading ring 190 may be positioned within the annular recess 180 of the core 170 and then melted. Once melted, the metal (e.g., copper) of the shading ring 190 fills the annular recess 180 of the core 170. As the metal of the shading ring 190 cools, the shading ring 190 shrinks within the annular recess 180 to form an interference fit with an inner wall of the annular recess 180 of the core 170. To achieve this interference fit, the shading ring 190 may be formed of a metal having a different coefficient of thermal expansion than the core 170 so that the shading ring 190 shrinks about the core 170 to secure the shading ring 190 to the core 170. By affixing the shading ring 190 to the core 170 in this manner, the tolerances of both the shading ring 190 and the annular recess 180 of the core may be less precise. In yet another embodiment, a metal (e.g., copper) is melted or impregnated into the end of the rod portion 174 of the core 170.

The disc portion 176 of the core 170 has a diameter larger than the inner diameter of the tube portion 128 of the bobbin 120 and thus remains outside the tube portion 128 of the bobbin 120 when the rod portion 174 is inserted into the tube portion 128. A back surface 187 of the core 170 engages the carrier 300. The core 170 may be formed of a powdered metal having high magnetic permeability characteristics to confine and guide the magnetic field induced by the coil of wire 152 during energization of the solenoid 100. Using a material with high magnetic permeability characteristics may reduce the magnetic reluctance of the magnetic circuit of the solenoid 100 thereby increasing the overall efficiency of the solenoid 100.

As shown in FIGS. 6A-6C, the disc portion 176 includes rounded edges 182 and straight edges 184 connecting the rounded edges 182. Including flattened or straight edges 184 on the disc portion 176 may improve the fit between the core 170, the bobbin 120, and the carrier 300. Specifically, including a straight edge 184 on the disc portion 176 of the core 170 allows the carrier 300 to be bent more sharply and have a smaller bend radius. This may improve the connection between the back surface 187 of the core 170 and the carrier 300 which may improve the magnetic circuit interface. In alternative embodiments, the disc portion 176 of the core 170 is circular such that there are no straight edges.

The disc portion 176 of the core 170 includes four apertures 172 extending therethrough. While four apertures 172 are shown, in alternative embodiments, the disc portion 176 may include any number of apertures 172, for example, three or five apertures. These apertures 172 may align with protrusions 156 extending from the end surface 134 of the bobbin 120 such that the protrusions 156 extend through the apertures 172 of the core 170. Once the protrusions 156 are positioned within the apertures 172, the ends of the protrusion 156 may be deformed, for example, by heat staking, to prevent the protrusions 156 from being withdrawn from the apertures 172. The apertures 172 may include a chamfered edge 186 about the circumference of the apertures 172. The chamfered edges 186 about the apertures 172 thus provide the core 170 with countersunk holes. When the protrusions 156 of the bobbin 120 are deformed, the material of the deformed (e.g., melted) protrusion 156 may be contained within the void formed by the aperture 172 and chamfer 186 such that it does not extend beyond the back surface 187 of the core 170. This ensures that the carrier 300 abuts the back surface 187 of the core 170 thereby improving the efficiency of the magnetic circuit of the solenoid 100.

As shown in FIG. 8, a gasket 188 may be positioned between the disc portion 176 of the core 170 and the end surface 134 of the bobbin 120. As an example, the gasket 188 may be an O-ring. The gasket 188 may prevent the plastic of the overmold housing 102 from flowing into the tube portion 128 of the bobbin 120 during manufacturing of the solenoid 100.

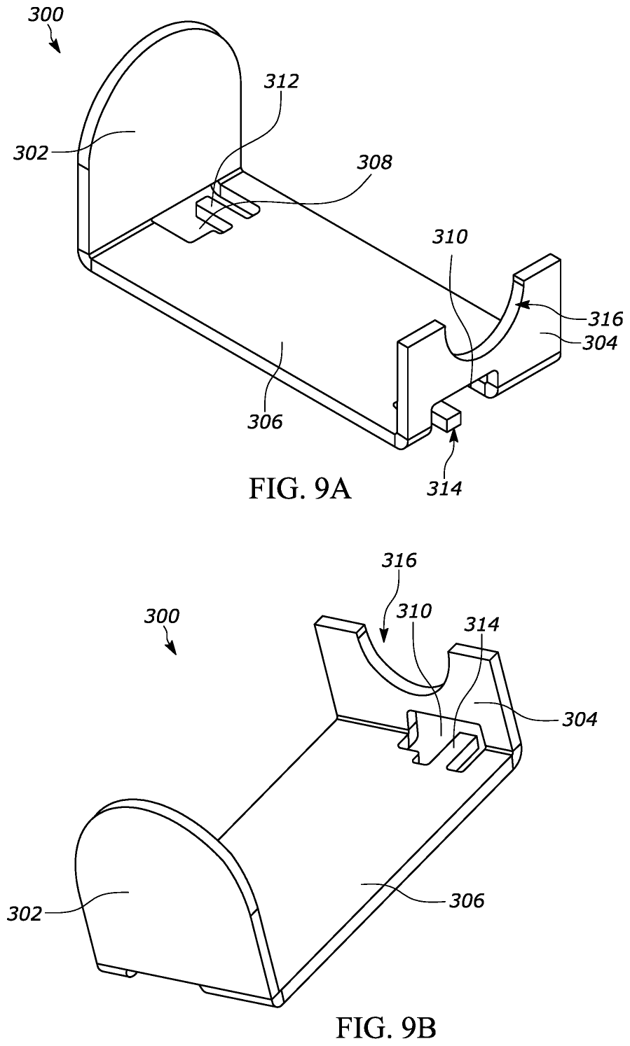

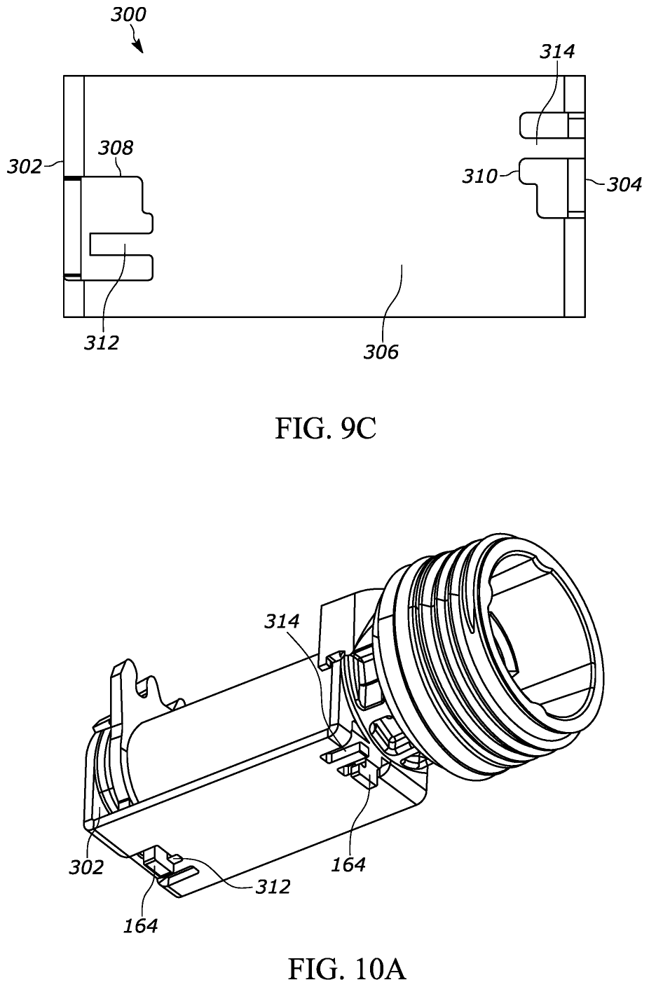

With reference to FIGS. 9A-9C, the carrier 300 includes a first end surface 302 connected to a second end surface 304 by a longitudinal portion 306. In one form, the first and second end surfaces 302, 304 of the carrier 300 are bent at about a 90 degree angle from the longitudinal portion 306 thus giving the carrier a C-shape. When assembled, the first end surface 302 of the carrier 300 contacts the back surface 187 of the disc portion 176 of the core 170. The second end surface 304 of the carrier 300 extends to the first end 134 of the tube portion 128 of the bobbin 120 opposite the core 170. The second end surface 304 of the carrier 300 defines a semi-circular cutout 316 that has a radius similar to the radius of the exterior surface of the tube portion 138 of the bobbin 120. The semi-circular cutout 316 abuts the exterior surface of the tube portion 128 of the bobbin 120.

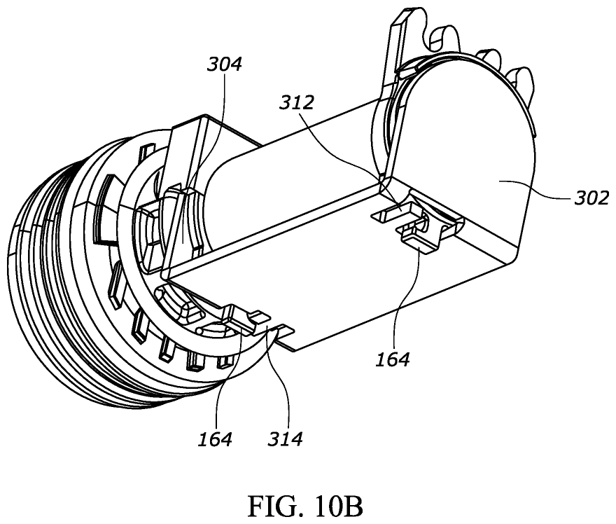

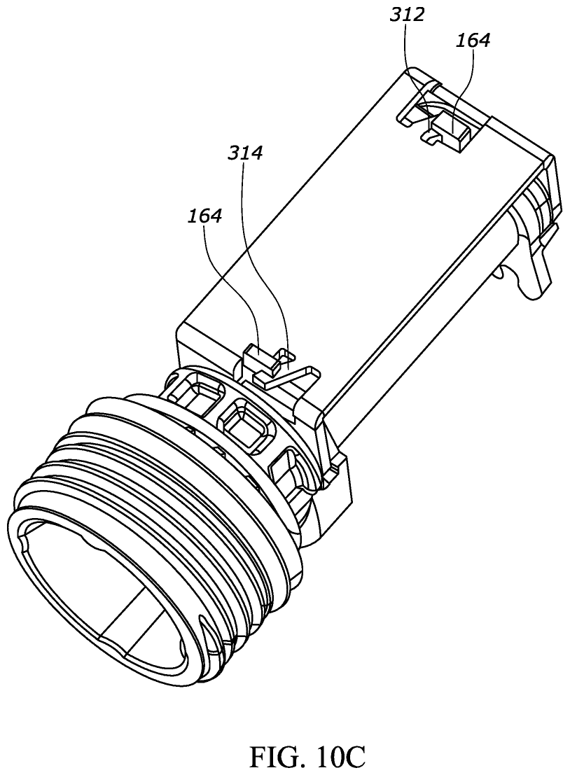

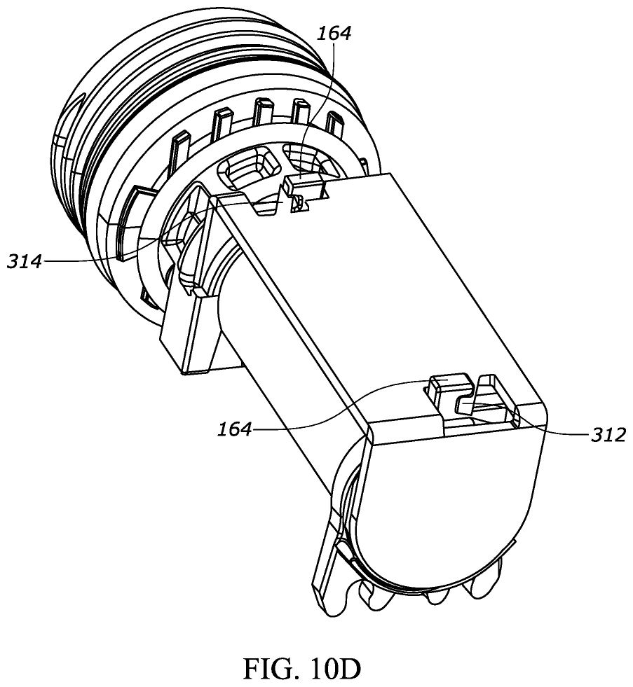

The carrier 300 further defines two attachment cutout portions 308, 310. Extending into each attachment cutout portion 308, 310 is an attachment finger 312, 314. The attachment fingers 312, 314 are used to attach the carrier 300 to the bobbin 120 via the hooks 164 of the bobbin 120 having a half-T configuration. With reference to FIGS. 10A-10C, the carrier 300 is attached to the bobbin 120 by engagement of the hooks 164 with the attachment fingers 312, 314. In attaching the bobbin 120 to the carrier 300, the hooks 164 are extended through the attachment cutout portions 308, 310 of the carrier 300. The fingers 312, 314 are then deformed or bent under the hooks 164 as shown in FIGS. 10C-10D. With the fingers 312, 314 between the hooks 164 and the main portion of the bobbin 120, the carrier 300 is mechanically attached to the bobbin 120.

With reference to FIG. 11, the carrier 300 is attached to a bobbin 120 having hooks 164 with a T-shape configuration. According to this embodiment, the carrier 300 defines two attachment cutout portions 308, 310. Extending into attachment cutout portion 308 are two attachment fingers 312, 322. Extending into attachment cutout portion 310 are two attachment fingers 314, 324. To attach the carrier 300 to the bobbin 120. the T-shaped hooks 164 of the bobbin 120 are extended through the attachment cutout portions 308, 310. Fingers 312, 322 and fingers 314, 324 are bent inward and under the hooks 164. With the fingers 312, 314, 322, 324 being between the hooks 164 and the main portion of the bobbin 120, the carrier 300 is mechanically attached to the bobbin 120.

In both embodiments, the attachment of the carrier 300 to the bobbin 120 aids in handling and moving the partially assembled solenoid 106, for example, when moving or positioning the partially assembled solenoid 106 for overmolding. The attachment of the carrier 300 to the bobbin 120 also aids in holding the carrier 300 in place during overmolding, such that the first end surface 302 of the carrier 300 remains in contact with the back surface 187 of the core 170. In other embodiments, the bobbin 120 may have one hook 164 that has a half-T configuration and one hook 164 that has a full-T configuration. The carrier 300 may also have one attachment cutout portion with one finger and another attachment cutout portion with two fingers to connect to the bobbin 120.

The carrier 300 may be made of a metal material, such as a metal having a high magnetic permeability to confine and guide magnetic fields induced by the coil of wire 152 during operation of the solenoid 100. Using a material for the carrier 300 with a high magnetic permeability results in a magnetic circuit with a reduced magnetic reluctance which may increase the overall efficiency of the solenoid 100. Using the embodiment where the bobbin 120 includes half-T hooks 164 and a carrier 300 having one finger for each attachment cutout portion may improve the efficiency of the magnetic circuit of the solenoid 100. This may be due in part to the carrier 300 having a greater cross-sectional width of the carrier 300 that the magnetic flux travels through when the solenoid 100 is in operation.

The C-shaped carrier 300 may be used in place of cylindrical frames and yokes that surround the bobbin found in other solenoids. The C-shaped carrier 300 improves the moldability of the solenoid 100 compared to cylindrical frames. For instance, the C-shape geometry of the carrier 300 provides less flow disturbances and resistance in the molding process, thereby creating fewer areas that are prone to circulation, stagnation, gas entrapment, and voids within the mold.

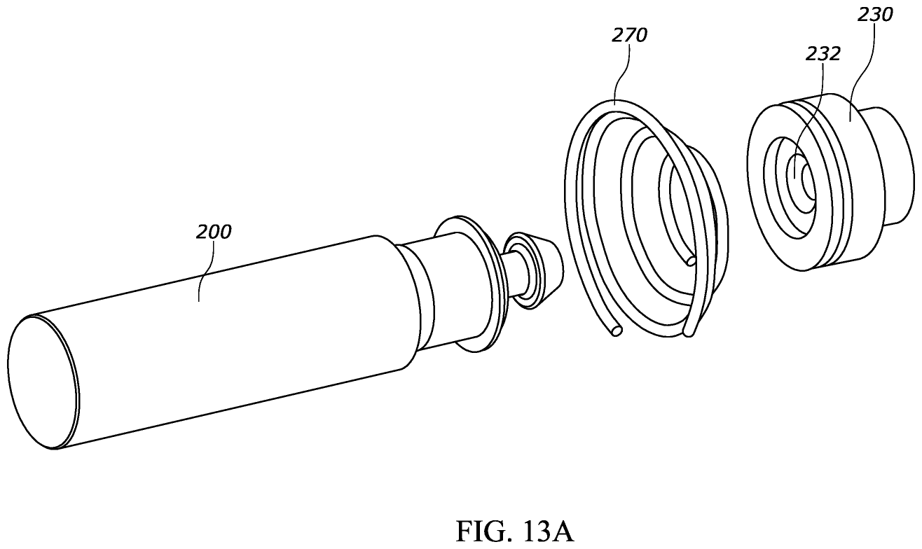

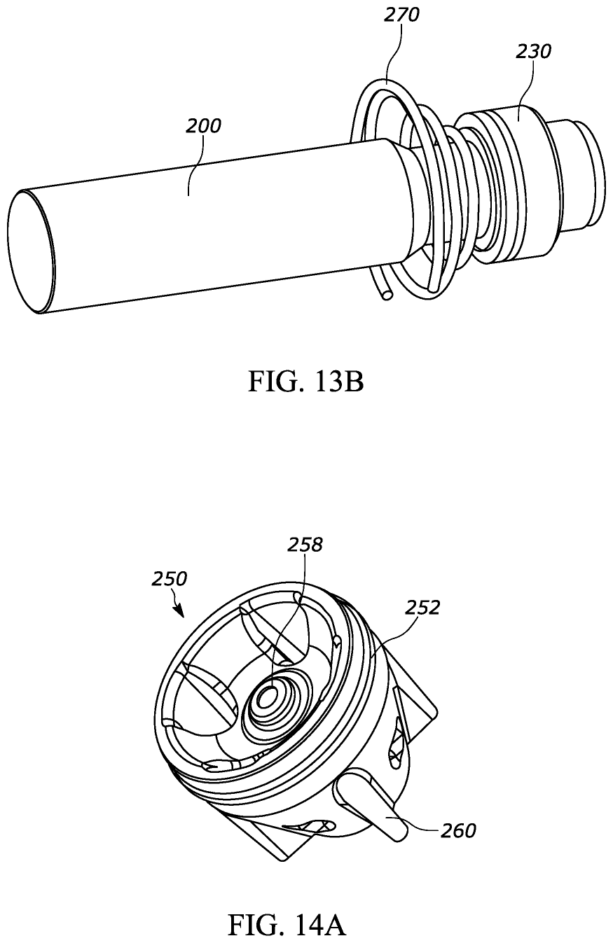

With reference to FIG. 12 and FIGS. 13A-13B, the plunger 200 includes a substantially cylindrical body 202 extending longitudinally from an end surface 204 to a head 206. The head 206 is connected to the body 202 by a neck 208 having a diameter small than that of the body 202 and the head 206 forming shoulder 210. The sealing cap 230 may include a recess 232 sized and shaped to receive the head 206 of the plunger 200 and hook the shoulder 210. The head 206 includes an angled surface 212 extending from the shoulder 210 which may aid in inserting the head 206 into the recess 232 of the sealing cap 230, but resist becoming unintentionally dislodged. The body 202 further includes a small diameter portion 214, a flange 216, and a large diameter portion 218. Once assembled, as shown in FIG. 13B, the spring 270 is wrapped around the small diameter portion 214 and engages the flange 216, biasing the plunger 200 longitudinally away from the core 170. The diameter of the spring 270 at the end wrapped around the plunger 200 is substantially the same as the small diameter portion 214. The spring 270 is unable to slide off the plunger 200 because the diameter of the spring 270 connected to the plunger 200 is too small to slide over the large diameter portion 218 or the flange 216.

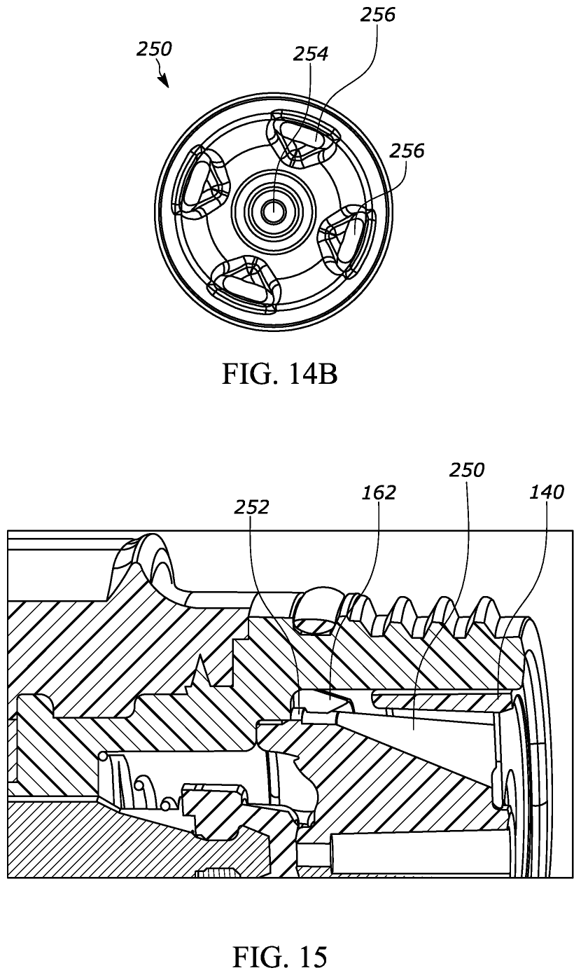

With reference to FIGS. 14A-14B and 15, the solenoid includes a retainer 250 that may be inserted into the valve cavity 124 of the bobbin. The radial outer surface of the retainer 250 includes a ridge 252 that the retention members 162 of the bobbin 102 engage to hold the retainer 250 in place. When inserting the retainer 250 into the bobbin 102, the ridge 252 may engage and deflect the retention members 162 radially outward as the retainer 250 is moved longitudinally into the valve cavity 124. After the ridge 252 passes beyond a hook portion of the retention members 162, the retention members 162 may snap over the ridge 252 and back to their original position thereby holding the retainer 250 in place. The retainer 250 keeps the plunger 200 at least partially within the tube portion 128 of the bobbin 120.

The retainer 250 defines the fluid flow path to and from the main valve. The retainer 250 includes an outlet passageway 254 extending longitudinally through a center portion of the retainer 250. The retainer 250 further includes inlet passageways 256 extending longitudinally through portions of the retainer 250 radially outward from the outlet passageway 254. It will be understood by those having skill in the art that the direction of fluid flow may also be reversed. As explained above, the plunger 200 is biased by the spring 270 to bring the sealing cap 230 into contact with the retainer 250. The sealing cap 230 is brought into contact with a seat 258 of the retainer 250 surrounding the outlet passageway 254. When the sealing cap 230 is in contact with the seat 258, the outlet passageway 254 is covered, thereby prohibiting fluid communication between the inlet and outlet passageways 254, 256 of the retainer 250. Such a configuration results in the solenoid 100 maintaining the valve in a normally closed position. The retainer 250 may further include a plurality of fins 260 disposed longitudinally along the outer surface of the retainer 250.

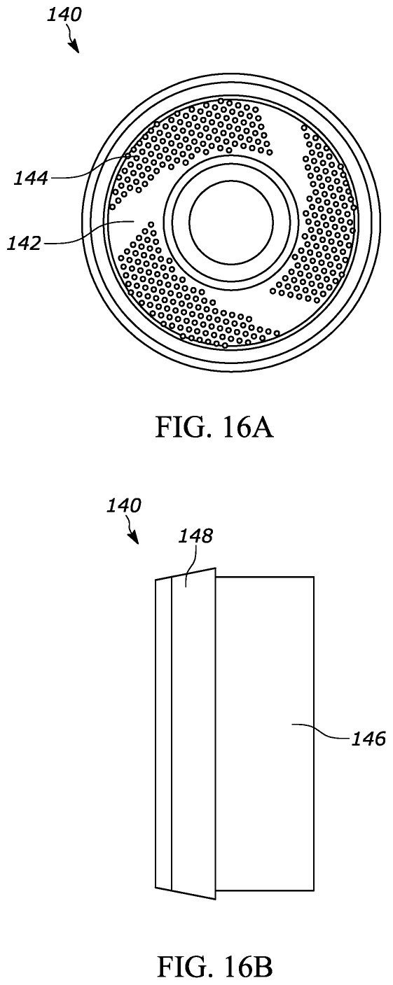

With reference to FIG. 16A-16B, the solenoid 100 includes a circular filter 140. The filter 140 is sized to be positioned within the cylindrical valve cavity 124 of the bobbin 120. The filter 140 includes a filter screen 142 having a plurality of apertures 144 therethrough sized to prevent particles in the fluid from passing further into the valve cavity 124. The filter 140 includes a sidewall 146 extending longitudinally from the filter screen 142. The sidewall 146 includes a protrusion 148 extending radially outward from the sidewall. The protrusion 148 holds the filter 140 in place within the valve cavity 124 of the bobbin 120 by a friction fit between the radial outer surface of the protrusion 148 and the inner surface of the valve cavity 124 of the bobbin 120.

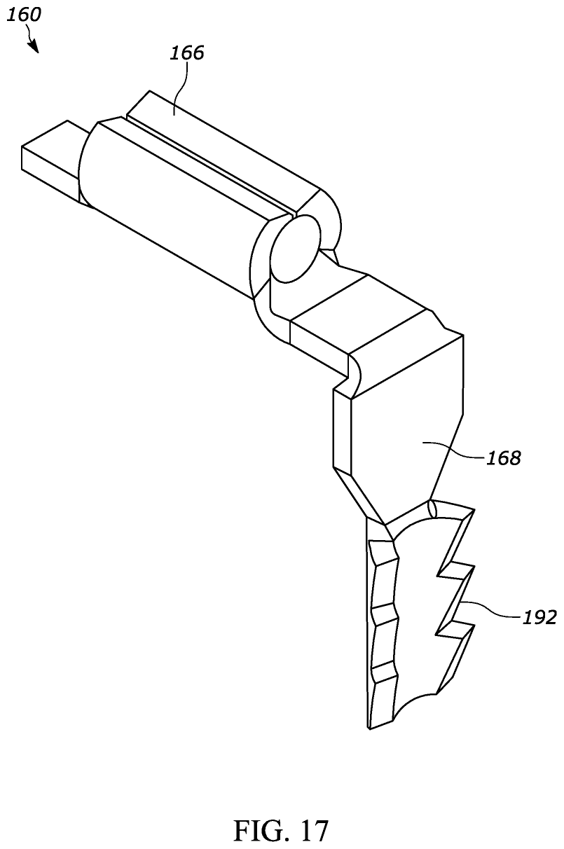

With reference to FIG. 3, a coil of wire 152 is wound around the tube portion 128 of the bobbin 120. The ends of the coil of wire 152 connect to terminals 160 inserted into the bobbin 120 near the attachment portion 122. As shown in FIG. 17, the terminals 160 include a first portion 166 for receiving the wires 104 from a power source and a second portion 168 for insertion into the sockets 158 of the bobbin 120 and contacting the ends of the wire of the coil 152. The first portion 166 may include a partial tube that the ends of wires 104 are inserted into. Once inserted, the first portion 166 may be crimped or clamped about the wires 104 to hold the wires 104 in place. In other embodiments, the wires 104 may be soldered to the first portion 166. In one form, the terminals 160 are bent such that the first portion 166 of the terminal 160 forms an approximate right angle with the second portion 168 of the terminal 160. The first portion 166 of the terminal 160 extends in the longitudinal direction away from the attachment portion 122 of the bobbin 120 and the second portion 168 of the terminal 160 is inserted toward an inner portion of the bobbin 120. The second portion 168 may include barbs 192 that allow for insertion into the socket 158 but resist removal. In another embodiment, the second portion 168 of the terminals 160 may be sized to be retained within the socket 158 by a friction fit. The ends of the coil 152 may be brought into contact with the second portion 168 of the terminals 160 to form an electrical connection between the power source and the coil 152. As examples, the ends of the coil of wire 152 may wrapped around and/or soldered to the second portion 168 of the terminals 160. The ends of the coil 152 may also be connected to contacts within the sockets 158 that the terminals 160 contact upon insertion into the sockets 158. The wires 104 from the power source extend through the wire guides 154 of the bobbin 120.

In operation, electrical power is supplied to the terminals 160 via the wires 104 extending from a power source. Current flows through the coil of wire 152 wrapped about the bobbin 120. The flow of current through the coil 152 induces a magnetic field that forms a loop extending through the inner diameter of the coil and returning around the exterior of the coil 152 thereby forming a magnetic circuit. The magnetic circuit carrying the magnetic field about the loop include the core 170, the plunger 200, and the carrier 300. The magnetic field also may pass through the other components of the solenoid 100 and environment surrounding the solenoid. The magnetic field acts on the plunger 200 which is partially disposed within the inner diameter of the coil 152. The magnetic attractive force on the plunger 200 overcomes the biasing force of the spring 270 and draws the plunger 200 toward the core 170. This moves the sealing cap 230 from the seat 258 of the retainer 250, allowing fluid to flow from the inlet passageways 256 and through the outlet passageway 254 of the retainer 250.

The solenoid 100 may be manufactured according to the following steps, although it will be understood to those having skill in the art that the steps and order of the steps may be modified. A wire may be wound about the tube portion 128 of the bobbin 120 to form the coil of wire 152. The ends of the coil of wire may be electrically connected to the second portion 168 of the terminals 160, with the second portion 168 of the terminals 160 being inserted into the sockets 158 of the bobbin 120. The power supply wires 104 may be connected to the first portion 166 of the terminals 160. The first portion 166 may be crimped or clamped about the wires 104. The wires 104 may be snapped into the wire guides 154 of the bobbin 120.

The shading ring 190 may be inserted into the annular recess 180 of the core 170. The shading ring 190 may be held in the annular recess by an adhesive or be sized to be retained within the annular recess 180 by a friction fit. A gasket 188 may be placed over the rod portion 174 of the core 170. The rod portion 174 of the core 170 may then be inserted into the second end 132 of the tube portion 128 of the bobbin 120. The protrusions 156 extending from the end surface 134 of the bobbin 120 may be aligned with and inserted through the apertures 172 of the core 170. The ends of the protrusions 156 extending through the end surface 134 may then be deformed to prevent the ends of the protrusions 156 from being able to pass back through the apertures 172. The protrusions 156 may be deformed, for example, by applying heat to the protrusions 156.

The carrier 300 may then be attached to the bobbin 120. The first end surface 302 is positioned behind the core 170 such that the core 170 is between the first end surface 302 of the carrier 300 and the bobbin 120. The second end surface 304 abuts the tube portion 128 of the bobbin 120 with the semi-circular cutout 316. The second end surface 304 is positioned within the cavity or slot 131 formed between the end surface 135 of the bobbin 120 and the attachment portion 122 of the bobbin 120. As the carrier 300 is brought into contact with the bobbin 120, the hooks 164 of the bobbin 120 are guided through the attachment cutout portions 308, 310 of the carrier 300. Once the hooks 164 have passed beyond the attachment fingers 312, 314 of the carrier 300, the fingers 312, 314 are bent inward and under the hooks 164. The fingers 312, 314 may be bent or deformed using servo motors configured to bend the fingers 312, 314 to a certain angle relative to their initial, unbent position.

The partially assembled solenoid 106 may then be placed in a mold and overmolded with a plastic to form the housing 102 covering the components on the outside of the tube portion 128 of the bobbin 120. The overmold extends from the attachment portion 122 of the bobbin 120 and covers the tube portion 128 of the bobbin 120, the terminals 160, the coil 152, the carrier 300, a portion of the wires 104, a portion of the core 170, and a portion of the gasket 188 in between the core 170 and the bobbin 120. In one embodiment, the overmold is dispersed over the partially assembled solenoid 106 from the side of the partially assembled solenoid 106 including the wires 104 and sockets 158. As the plastic flows into the mold and over the partially assembled solenoid 106, the shroud 194 redirects the flow around the interface of the first end surface 302 of the carrier and the back surface 187 of the core 170. This aids to prevent the plastic from flowing in between the carrier 300 and the core 170 to preserve the magnetic circuit interface between the components. In another embodiment, the plastic flows over the partially assembled solenoid 106 from the first end surface 302 of the carrier 300 toward the attachment portion 122 of the bobbin 120. In this embodiment, the plastic forces the first end surface 300 of the carrier against the core 170 as the plastic flows into the mold and over the partially assembled solenoid 106.

The plunger 200, retainer 250, gasket 150, spring 270, sealing cap 230, and filter 140 may be installed after the overmolding process, however, in some forms one or more of these components may be installed before the overmolding process. In this regard, the plunger 200 is positioned within the tube portion 128 of the bobbin 120 such that the end surface 204 of the plunger 200 is near the core 170. The spring 270 is attached to the small diameter portion 214 of the plunger 200 and the internal surface of the bobbin 120. The sealing cap 230 may be snapped onto the head 206 of the plunger 200. Once the plunger 200 is positioned within the bobbin 120, the retainer 250 is snapped into the valve cavity 124. To do this the ridge 252 of the retainer 250 is brought into contact with the retention members 162 of the bobbin 120. A longitudinal force is applied to the retainer 250, urging the retention members 162 apart to allow the ridge 252 of the retainer 250 to pass beyond the retention members 162. The retention members 162 then elastically move toward their original position hooking the ridge 252 and thereby securing the retainer 250 to the bobbin 120. The filter 140 may then inserted into the valve cavity 124 of the bobbin 120. An outer surface or protrusion 148 of the filter may be marginally larger than an inner surface of the valve cavity 124 such that the filter 140 is held in place by the friction between the outer surface of the filter 140 and the inner surface of the valve cavity 124. The filter 140 is forced to move longitudinally within the valve cavity 124 until it abuts the retainer 250.

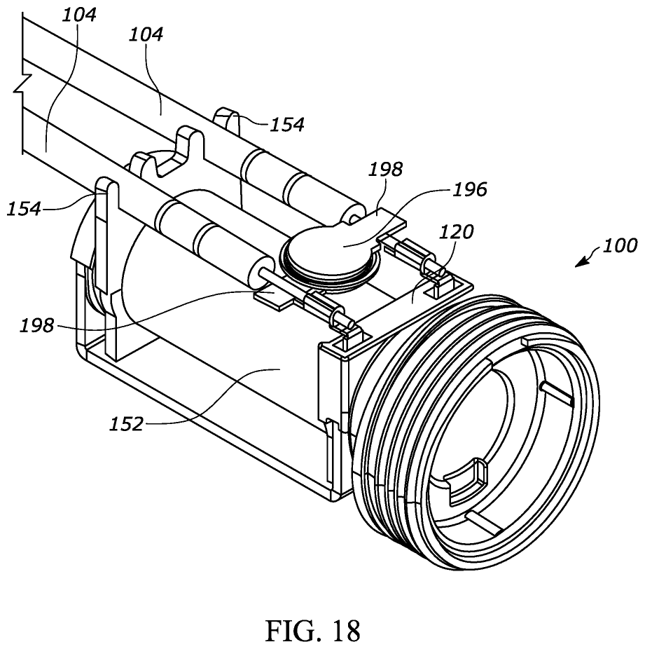

In another embodiment shown in FIG. 18, a solenoid 100 is shown having a gas discharge tube wire harness 196 attached across the wires 104 extending to the power source. The gas discharge tube wire harness 196 provides surge protection during high voltage events, such as a lightning strike, to protect the solenoid 100. The gas discharge tube wire harness 196 may be connected across wires 104 at pads 198. Pads 198 may be attached to the wires 104 by resistance welding or soldering as examples. As shown, the bobbin 120 of the solenoid 100 includes wire guides 154. The wire guides 154 are sized to receive the wires 104 attached to the terminals 160. The wires 104 of the solenoid 100 including a gas discharge tube may be thicker to withstand power surges, for example, 18-gauge wire. The wires 104 may be pressed into the wire guides 154. The wires may snap into the wire guides where they are held in place to prevent unintentional movement. The wire guides may hold the wires 104 and gas discharge tube wire harness 196 in place when they are being overmolded. The wire guides 154 may aid to prevent the wires and gas discharge tube wire harness 196 from coming into contact with the coil 152, which may cause the solenoid to fail prematurely.

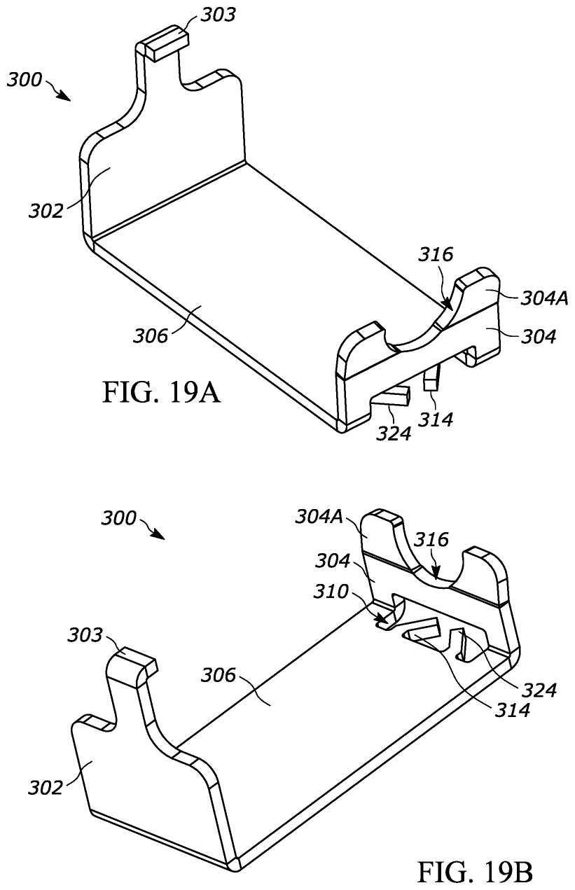

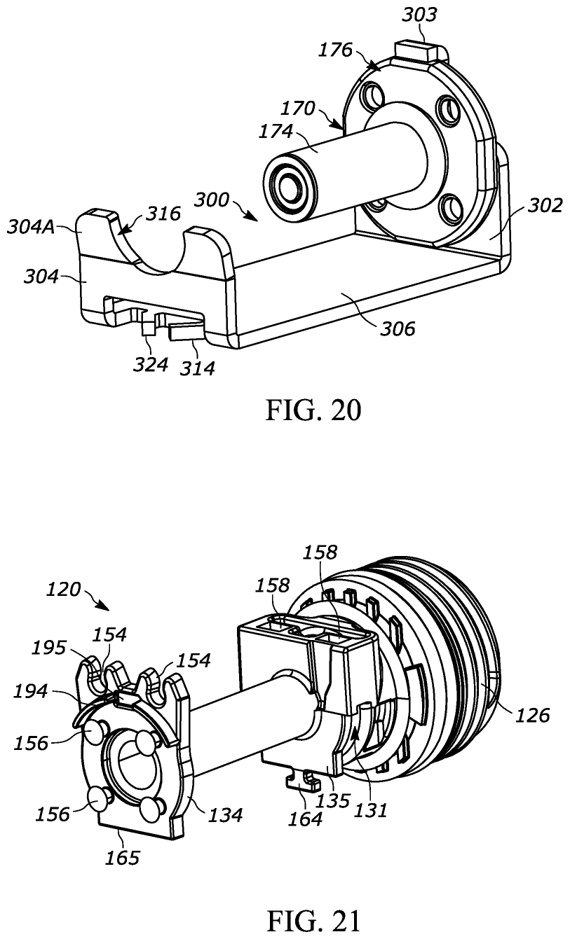

With respect to FIGS. 19-23B, additional embodiments of the various components of the solenoid 100 are shown that are similar in many respects to the embodiments of the solenoid 100 discussed above, the differences of which are highlighted in the following discussion. For conciseness and clarity, the reference numerals of the embodiments of the components described above will be used to indicate similar features in the additional embodiments described below. With reference to FIGS. 19A-19B, the first end surface 302 of the carrier 300 includes a bent tab 303 extending away from the longitudinal portion 306. The bent tab 303 is positioned to extend over a straight edge 184 of the core 170. The bent tab 303 may be spaced apart from the longitudinal portion 306 such that the core 170 may be attached to the carrier 300 and firmly held in place between the bent tab 303 and the longitudinal portion 306 as shown in FIG. 20, for example, during assembly of the solenoid 100. The bent tab 303 thus aids to hook the core 170 to secure the core 170 to the carrier 300. As shown in FIG. 21, the bobbin 120 may include a notch or recess 195 into which an end of the bent tab 303 may extend. The bent tab 303 thus aids to hook the bobbin 120 to secure the carrier 300 to the bobbin 120.

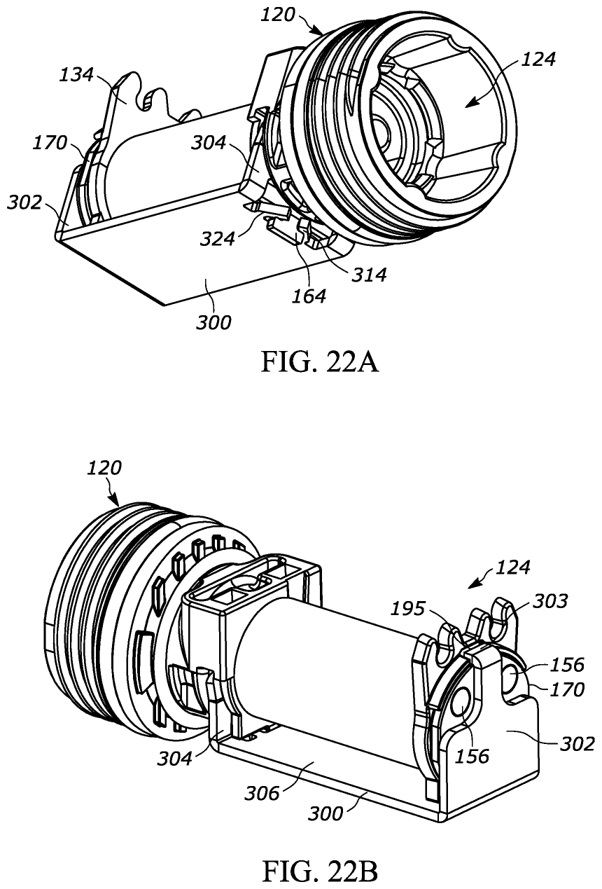

The carrier 300 further includes only one cutout portion 310 on the longitudinal portion 306 at the second end surface 304, rather than two cutout portions at each end as in the previous embodiments. The carrier 300 includes two fingers 314, 324 extending out into the cutout portion similar to the carrier shown and described in regard to FIG. 11 above. The fingers 314, 324 may be bent about the hook 164 of the bobbin 120 as shown in FIG. 22A to affix the carrier 300 to the bobbin 120. The second end surface 304 may further include a portion 304A that is bent longitudinally away from the first end surface 302. The bent portion 304A may include the semi-circular cutout 316 to enable the second end surface 304 to be positioned to abut the tube portion 128 of the bobbin 120. While the embodiment shown includes a full T-shaped hook 164, in other embodiments, the bobbin 120 may include a half T-shaped hook as shown, for example, in FIG. 10A. In these embodiments, the carrier 300 may include a single finger 314 that is deformed or bent about the half T-shaped hook 164.

With respect to FIG. 21, the end surface 134 of the bobbin 120 does not include a second hook 164, but instead includes a flat surface 165 to engage a top surface of the longitudinal portion 306 of the carrier 300 when attached thereto. The flat surface 165 may aid to prevent the carrier 300 from twisting or moving relative to the bobbin 120 when secured thereto. The end surface 134 of the bobbin 120 further includes the notch or recess 195 in the shroud 194 that may receive the bent tab 303 of the carrier 300 when the carrier 300 is attached to the bobbin 120. When the carrier 300 is attached to the bobbin 120 as shown in FIGS. 22A-B, the bent tab 303 is inserted into the recess 195 of the end surface 134. The bent tab 303 thus hooks the bobbin 120 which aids in affixing the carrier 300 to the bobbin 120. The carrier 300 may thus be secured to the bobbin 120 for assembly by hooking the bent tab 303 into the recess 195 of the bobbin 120 and bending the fingers 314, 324 about the hook 164 of the bobbin 120.

In some forms, to attach the carrier 300 to the bobbin 120, the second end surface 304 is inserted within the cavity 131 of the bobbin 120. The carrier 300 is pivoted to bring the bent tab 303 toward the recess 195 of the bobbin 120. The bent tab 303 may be slid along the core 170 until the bent tab 303 snaps over the top edge 184 of the core 170. In some forms, the bent tab 303 may snap into the recess 195 of the bobbin 120. As the carrier 300 is pivoted, the bent portion 304A of the second end surface 304 of the carrier 300 may be forced against the attachment portion 122 of the bobbin 120. The bent portion 304A may be elastically deflected such that the bent portion 304A provides an increased frictional engagement between the second end surface 304 and the attachment portion 122 of the bobbin 120, which aids to prevent the carrier 300 from moving relative to the bobbin 120. Once the bent tab 195 is within the recess 195, the fingers 314, 324 may be bent about the hook 164 of the bobbin 120 extending through the attachment opening or cutout portion 310.

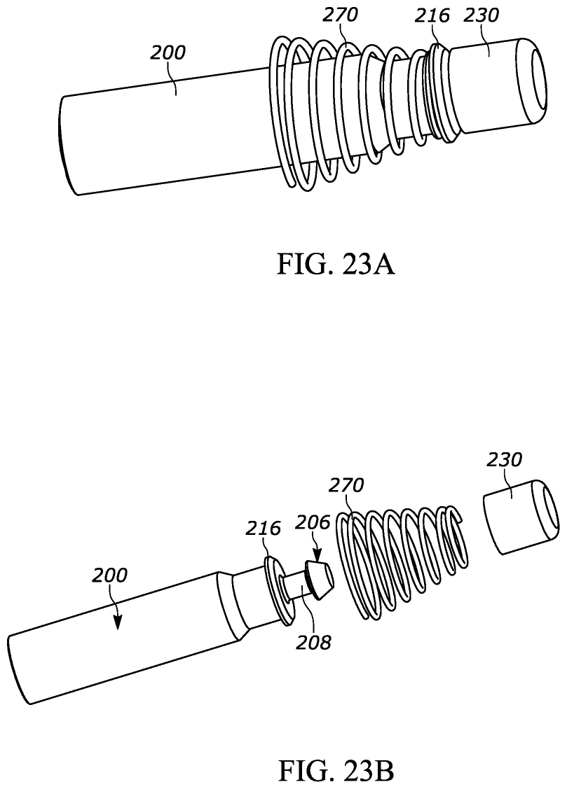

With respect to FIGS. 23A-B, the plunger 200, spring 270, and sealing cap 230 are shown. As shown, the spring 270 extends further longitudinally in its uncompressed state than the spring in the previous embodiments. The spring 270 of this embodiment may apply a greater force to the flange 216 of the plunger 200 to force or bias the plunger 200 into engagement with the seat 258 of the retainer 250. The sealing cap 230 of this new embodiment has a substantially cylindrical shape with an outer diameter that is not greater than the outer diameter of the flange 216.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the technological contribution. The actual scope of the protection sought is intended to be defined in the following claims.

What is claimed is:

1. A solenoid comprising:
a bobbin;
a core wire forming a coil about at least a portion of the bobbin;
a power supply wire electrically coupled to an end of the core wire;
a frame secured to the bobbin, the frame including a first end portion extending adjacent a first end of the coil, a second end portion extending adjacent a second end of the coil, and a longitudinal portion extending from the first end portion to the second end portion; and
an overmolded housing surrounding the core wire, the frame, and a portion of the power supply wire.

2. The solenoid of claim 1 wherein the bobbin includes a wire guide to support the power supply wire and restrict movement of the power supply wire relative to the bobbin when the housing is overmolded over the portion of the power supply wire.

3. The solenoid of claim 1 wherein the bobbin includes an attachment hook and the frame is connected to the bobbin by the attachment hook.

4. The solenoid of claim 3 wherein the frame includes an attachment opening and a tab extending into the attachment opening, the tab engaging the attachment hook of the bobbin to secure the frame to the bobbin.

5. The solenoid of claim 1 wherein the attachment hook has at least one of a half-T or a T-shaped configuration.

6. The solenoid of claim 1 wherein the frame is generally C-shaped having the first end portion and the second end portion extending substantially perpendicularly from the longitudinal portion.

7. The solenoid of claim 1 wherein the first end portion of the frame includes a tab protruding therefrom that extends into a recess of the bobbin.

8. The solenoid of claim 1 further including a gas discharge tube connected to the power supply wire and surrounded by the overmolded housing.

9. The solenoid of claim 1 further comprising a core positioned at least partially within an end portion of the bobbin, wherein the bobbin includes a shroud extending longitudinally from the end portion of the bobbin and over at least a portion of the core and the frame outside the bobbin.

10. The solenoid of claim 9 wherein the core includes a base portion defining a plurality of countersunk holes and the end portion of the bobbin includes a plurality of protrusions extending through the attachment openings, the plurality of protrusions being deformed to prevent the plurality of protrusions from being withdrawn from the core.

11. The solenoid of claim 10 wherein the base portion is disc shaped having a radial outer surface of the base portion including a flat edge, an end surface of the base portion of the core contacting the first end portion of the frame and the flat edge of the core contacting the longitudinal portion of the frame.

12. The solenoid of claim 9 wherein the core includes a rod portion having an end defining an annular recess and further comprising a metallic ring positioned within the annular recess and attached to the core via an interference fit.

13. A method of forming a solenoid comprising the steps of:
winding a wire around a bobbin to form a coil;
electrically coupling a first end of the wire to a power supply wire;
inserting a portion of a core into an opening at a first end of the bobbin such that the coil encircles the portion of the core;
attaching a frame to the bobbin such that a first end of the frame contacts the core and a second end of the frame contacts a portion of the bobbin adjacent a second end of the coil; and
overmolding a housing about the coil, the frame, the connector, and a portion of the power supply wire.

14. The method of claim 13 wherein overmolding the housing includes injecting plastic over the coil, the frame, the connector, and the portion of the power supply wire, the bobbin including a shroud diverting the flow of the injected plastic from an interface between the first end of the frame and the core.

15. The method of claim 13 wherein attaching the frame to the bobbin includes inserting a hook of the bobbin through an attachment opening of the frame and deforming an attachment tab of the frame about the hook of the bobbin.

16. The method of claim 15 wherein the frame is generally C-shaped such that the first end extends from a longitudinal portion of the frame at an angle and the second end extends from the longitudinal portion an angle.

17. The method of claim 16 wherein the longitudinal portion of the frame includes the attachment opening.

18. The method of claim 13 further comprising the step of snap or friction fitting the power supply wire into a wire guide of the bobbin.

19. The method of claim 13 further comprising attaching a gas discharge tube to the power supply wire.

20. The method of claim 13 further comprising the steps of inserting a shading ring into an end of the core and heating the shading ring and core to deform at least one of the shading ring and the core.

21. A solenoid comprising:
a bobbin having a securing protrusion;
a core wire forming a coil about at least a portion of the bobbin; and
a frame secured to the bobbin, the frame including a first end portion extending adjacent a first end of the coil, a second end portion extending adjacent a second end of the coil, and a longitudinal portion extending from the first end portion to the second end portion, the longitudinal portion including a slot for receiving the securing protrusion to couple the bobbin to the frame.
